(19) United States
(12) Patent Application Publication
(10) Pub. No.: US 2009/0272674 A1
(43) Pub. Date: Nov. 5, 2009

(54) Nano zeolite containing hydrotreating catalyst and method of preparation

(76) Inventors: Ying Zheng, New Maryland (CA); Lianhui Ding, Edmonton (CA); Zisheng Zhang, Ottawa (CA); Zbigniew Ring, Naperville, IL (US)

Correspondence Address: DOWELL & DOWELL P.C., 103 Oronoco St., Suite 220, Alexandria, VA, 22314, US

(21) Appl. No.: 12/149,394

(22) Filed: Apr. 30, 2008

(51) Int. Cl. C10G 45/00; B01J 29/06

(52) U.S. Cl. 208/216 PP; 502/64; 502/60; 502/74

(57) ABSTRACT

The present invention provides nano zeolite containing hydrotreating catalyst and methods of preparation, and more particularly to a nano-sized zeolite beta composite hydrotreating catalyst. The hydrotreating catalyst for desulfurization of diesel distillates includes between about 5 to about 75 wt % nano-sized zeolite beta composite, about 10 to about 30 wt % of a hydrogenation metal/alloy and between about 5 to about 20 wt % binder.

### FIELD OF THE INVENTION

The present invention generally relates to nano zeolite containing hydrotreating catalysts and methods of preparation, and more particularly to a nano-sized zeolite beta composite hydrotreating catalyst.

### BACKGROUND OF THE INVENTION

Two-stage hydrocracking is a process combining catalytic cracking and hydrogenation, wherein heavier feedstocks are cracked in the presence of hydrogen to produce more desirable products. This is an important technology for producing high-value naphtha or distillate products from a wide range of refinery feedstocks, especially as applied to produce diesel fuels with very low aromatics content in the second stage in which the noble metals catalyst is usually used and the catalyst is easily poisoned by sulfur compounds. In the two-stage process, a preheated hydrocarbon feedstock is mixed with recycled hydrogen and sent to the first-stage reactor, where catalysts convert sulfur and nitrogen compounds to hydrogen sulfide and ammonia. Limited hydrocracking also occurs. The effluent from the first stage is separated and fractionated. The unconverted oil (fractionator bottom) is passed into a second reactor.

Depending on the products desired (gasoline components, jet fuel, diesel fuel, or gas oil), the fractionator is run to cut out some portion of the first stage reactor out-turn. The fractionator bottoms are again mixed with a hydrogen stream and charged to the second stage. Since this material has already been subjected to some hydrogenation, cracking, and reforming in the first stage, most importantly the H₂S and ammonia poisons have been removed, and the operations of the second stage can be milder.

Hydrotreating is another most commonly used refinery processing process to treat inferior diesel distillates. By comparison, hydrotreating technology is designed to remove contaminants such as sulfur, nitrogen, condensed ring aromatics, or metals. Typically, hydrotreating is done prior to processes such as catalytic reforming so that the catalyst is not contaminated by untreated feedstock. Hydrotreating is also used prior to catalytic cracking to reduce sulfur and improve product yields, and to upgrade middle-distillate petroleum fractions into finished kerosene, diesel fuel, and heating fuel oils. In addition, hydrotreating converts olefins and aromatics to saturated compounds.

Hydrotreating for sulfur removal is called hydrodesulfurization (HDS). In a typical catalytic HDS unit, the feedstock is deaerated and mixed with hydrogen, preheated in a fired heater (600°-800° F.) and then charged under pressure (up to 1,000 psi) through a fixed-bed catalytic reactor. In the reactor, the sulfur and nitrogen compounds in the feedstock are converted into H₂S and NH₃. The reaction products leave the reactor, after heat-exchanged with feedstock to a low temperature, to enter a liquid/gas separator.

The hydrogen-rich gas from a high-pressure separator is recycled to mix with the feedstock, and the low-pressure gas stream rich in H₂S is sent to a gas treating unit where H₂S is removed. The clean gas is then suitable as fuel for the refinery furnaces.

The hydrotreating reaction, which is used extensively both for the conversion of heavy feedstocks and to improve the quality of the final products, represents one of the most important catalytic processes in the petroleum refining industry. This process mainly aims at removing heteroatoms, such as sulfur, nitrogen, metals, and oxygen, in order to protect catalysts in downstream operations. Today, the greater needs for processing heavier feedstocks enhance the pressure to improve hydrotreating processes, as oil supplies decline. Moreover, worldwide environmental legislation places increasingly severe restrictions on transportation fuels. Hence, processes such as deep desulfurization and dearomatization will become more and more important for providing environmentally friendly fuel.

Sulfur compounds present in diesel fuel can be divided into two groups. Compounds such as thiols, sulfides, and thiophenes form a first group, whereas thiophenic polyaromatic molecules form the second. The distinction between these two groups relates to the relative activity of the molecules with respect to hydrodesulfurization. The molecules of the first group do not cause problems in industrial HDS. Hence, emphasis has been placed on understanding of the reactivity and HDS mechanisms of benzothiophene (BT) and dibenzothiophene (DBT) in the past decade. Alkylated DBTs are particularly resistant to HDS, especially when alkylated in the 4 and 6 positions. It has been previously reported that the DBT and 4,6-DMDBT undergo HDS via two reaction pathways:

(1) direct desulfurization (DDS), which leads to the formation of biphenyls; and
(2) hydrogenation (HYD) yielding tetrahydro- and hexahydro-intermediates followed by desulfurization to cyclohexylbenzenes and bicyclohexyls, see P. Michaud, J. L. Lemberton and G. Pérot, Appl. Catal. A: Gen. 169 (1998), p. 343.

Conventional hydrotreating catalysts include NiMo/Al₂O₃ and CoMo/Al₂O₃. Introduction of an acid function to the conventional hydrotreating catalyst leads to a bifunctional catalyst, which should promote the DDS, HYD, alkylation (ALK), cracking (CKG) and isomerization (ISO) of the reactive molecules (G. Perot, Catal. Today 86 (2003), p. 111; C. Kwak, J. Joon Lee, J. Sang Bae, K. Choi and S. Heup Moon, Appl. Catal. 200 (2000), p. 233. N. Kunisada, K. Choi, Y. Korai, I. Mochida and K. Nakano, Appl. Catal. A: Gen. 276 (2004), p. 51). HY Zeolite, USY zeolite or HZSM-5 zeolites were reported to be added into the conventional catalyst (N. Kunisada, K. Choi, Y. Korai, I. Mochida and K. Nakano, Appl. Catal. A: Gen. 276 (2004), p. 51; and M. V. Landau, D. Berger and M. Herskowitz, J. Catal. 159 (1996), p. 236).

The high acidity and hydrothermal stability of zeolite beta make it a great catalyst component in fluid catalytic cracking (L. Bonetto, M. A. Camblor, A. Corma, J. Perez-Pariente, Applied Catalysis A, 82 (1992) 37-50), hydrotreating (I. Kiricsi, C. Flego, G. Pazzuconi, W. O. Parker, R. Millini, C. Perego, G. Bellussi, J. Phys. Chem. 98 (1994)4627-4634.) and isobutene alkylation (A. Corma, A. Martinez, P. A. Arroyo, J. L. F. Monteiro, E. F. Sousa-Aguiar, Applied Catalysis A, 142 (1996)139-150).

However, its interconnected 12-membered ring channels, with pore openings of 0.55 nm×0.55 nm and 0.76 nm×0.64 nm, make it difficult for the large molecules present in oil fractions to diffuse to the inner surface where most of reactive sites are located. A decrease in crystal sizes to nanometer can, due to shorter diffusion paths of the reactant and product molecules inside the pores, result in a reduction or elimination of undesired diffusion limitations of the reaction rate, see J. Weitkamp, Zeolites and catalysis, Solid State Ionics 131 (2000) 175-188. Meanwhile, a decrease in the crystal size to the nanoscale range will rapidly increase its external surface and the fraction of acid sites, which will provide the active sites for the molecules that are too big to enter the pores of zeolites, see P. Botella, A. Corma, J. M. Lopez-Nieto, S. Valencia, R. Jacquot, J. Catal. 195 (2000) 161-168.

U.S. Patent Publication 20060260981 to Gosling discloses a process for the conversion of a hydrocarbon feedstock to produce olefins, aromatics compounds and ultra low sulfur diesel. Catalysts containing zeolite are used in a fluid catalytic cracking zone to produce a stream comprising ethylene and propylene as well as a stream comprising higher boiling olefins and light cycle oil.

U.S. Patent Publication 20060207917 to Laszlo et al. discloses an unsupported catalyst composition containing Group VIII and Group VIB metals, a zeolite and an optional inert refractory oxide. Laszlo teaches the catalyst is an unsupported catalyst, which is distinct from supported catalysts. Laszlo also teaches the catalyst is used in hydrocracking.

U.S. Patent Publication 20060118462 to Schulze-Trautmann et al. discloses a process for preparing microcrystalline paraffin from the Fischer-Tropsch synthesis and a use of this microcrystalline. The catalyst applied to this process contains zeolite beta, alumina and one or more metals of transition group 8 and emphasize isomerisation ability.

U.S. Patent Publication 20060057046 to Punke et al. discloses a catalyzed soot filter formed on a flow substrate having internal walls coated with catalyst compositions useful for the treatment of exhaust gases from diesel engines.

U.S. Pat. No. 7,094,333 issued to Yang et al. discloses adsorbent materials for adsorptive removal of thiophene and thiophene compounds from liquid fuel. The adsorbent materials contain zeolite but not in the form of nano-sized zeolite beta.

U.S. Pat. No. 6,982,074 issued to Jan et al. discloses a method to synthesize new crystalline microporous aluminosilicate zeolite designated UZM-5HS.

U.S. Pat. Nos. 6,929,738 and 6,863,803 issued to Riley et al. originate from the same parent patents and disclose a two-stage hydroprocessing process for producing low sulfur distillates. The cracking components used in the process include cationic clays, anionic clays, and zeolites.

U.S. Pat. No. 6,846,406 issued to Canos et al. discloses a process for the elimination of sulfur compounds from the gasoline fraction. The catalyst disclosed in Canos et al. is for oxidizing sulfur compounds in the gasoline fraction. Canos et al. discloses that the sulfur components of gasoline are eliminated through an oxidation reaction and separation of the oxidized components.

U.S. Pat. No. 6,811,684 issued to Mohr et al. discloses the synthesis of macrostructural sized catalytic materials for the applications of catalytic cracking, alkylation, dealkylation, dehydrogenation, disproportionation, transalkylation, hydrocracking, isomerisation, dewaxing, oligomerization and reforming processes.

U.S. Pat. No. 6,384,285 issued to Choudary et al. discloses a process for the preparation of 4′-isobutylacetophenone that uses metal exchanged nano- and microcrystalline zeolite beta for the acylation of isobutyl benzene. The metal component was ion-exchanged to zeolitic materials.

U.S. Pat. No. 6,316,674 issued to Kantam et al. is authored by the same inventors as the Choudary reference discussed above and discloses an improved process for the preparation of acyl aromatic ethers from aromatic ethers using C2-C8 acid anhydrides.

U.S. Pat. No. 6,190,538 issued to Gosselink et al. discloses a process for the preparation of a catalyst composition for use in hydrocracking processes which comprises zeolite beta and another cracking component. This catalyst has an improved hydrocracking activity coupled with good middle distillate selectivity. The catalyst also includes a gelatin material.

U.S. Pat. No. 5,954,947 issued to Mignard et al. discloses a process of hydrocracking for petroleum cuts. The catalyst used in Mignard et al. contains zeolite Y and one hydro-dehydrogenating element.

U.S. Pat. No. 5,171,331 issued to Debras et al. discloses a process for production of gasoline having an improved octane number. In accordance with the invention disclosed in Debras, there is provided an improved multi-step olefin oligomerization process for the production of gasoline.

Therefore there is a strong need for a hydrotreating catalyst for sulfur removal from diesel.

### SUMMARY OF THE INVENTION

The present invention provides a hydrotreating catalyst for desulfurization of diesel distillates comprising between about 5 to 75 wt % nano-sized zeolite beta composite, about 10 to about 30 wt % of hydrogenation metals and between about 5 to about 20 wt % binder.

A further understanding of the functional and advantageous aspects of the invention can be realized by reference to the following detailed descriptions.

### DETAILED DESCRIPTION OF THE INVENTION

The systems described herein are directed, in general, to embodiments of nano-sized zeolite beta composite hydrotreating catalysts, methods of making same and use of the catalyst for hydrotreating diesel for sulfur removal. Although embodiments of the present invention are disclosed herein, the disclosed embodiments are merely exemplary in nature.

Therefore, specific structural and functional details disclosed herein are not to be interpreted as limiting but merely as a basis for the claims and as a representative basis for enabling someone skilled in the art to employ the present invention in a variety of manners. For purposes of instruction and not limitation, the illustrated embodiments are all directed to nano-sized zeolite beta composite hydrotreating catalysts, methods of making same and use of the catalyst for hydrotreating diesel for sulfur removal.

As used herein, the term “about”, when used in conjunction with ranges of concentrations, temperatures or temperature ranges, dimensions or pressures or other physical properties or characteristics, is meant to cover slight variations that may exist in the upper and lower limits of the ranges of dimensions or pressures so as to not exclude embodiments where on average most of the dimensions are satisfied but where statistically dimensions may exist outside this region. It is not the intention to exclude embodiments such as these from the present invention.

As used herein, the phrase “nano-sized zeolite beta” means the crystal size of zeolite beta is from about 10 to about 100 nm, preferably, in the size range from about 20 to about 80 nm.

A hydrotreating catalyst containing nano-sized zeolite beta has been synthesized. The catalyst includes about 5 to about 75 wt % nano-sized zeolite beta containing composite, 10-30 wt % hydrogenation metals (for example, but not limited to, WNi or MoNi or MoCo), and 5-20 wt % binder such as, but not limited to, Al₂O₃. The detailed preparation method is described below.

First, the alumina-zeolite or amorphous Si—Al zeolite composite is prepared by the following method:

1) The nano-sized zeolite beta is synthesized in an autoclave using fumed silica, aluminum powder, and tetraethylammonium hydroxide (TEAOH) as silica source, aluminum source, and template agent respectively. The template agent (TEAOH) acts as a structure directing agent in forming desired pore structure. The roles of the template agent, particularly as a structure directing agent, are well known in the field of zeolite synthesis as will be appreciated by those skilled in the art. The precursor gels had the oxide molar compositions:

xTEAOH: ySiO₂: Al₂O₃:zH₂O

where x ranges from 5 to 50, y from 20 to 500, and z from 100 to 2000. The metal aluminum is dissolved in a portion of TEAOH-containing aqueous solution to form a clear solution. Then, this solution is added to the slurry made from fumed silica and the other portion of the TEAOH-containing aqueous solution. The formed aluminosilicate fluid gel is stirred at ambient temperature for 2 to 6 hours, and then transferred into a stainless steel autoclave. The crystallization is carried out at a temperature between about 350 K and about 550 K, preferably the temperature is in the range from about 373 to about 473K, either under the static state in an oven or under the agitation state. The autoclave is quenched to stop the crystallization process after various periods of crystallization time and a colloid is formed.
2) Aluminum chloride or aluminum sulfate aqueous solution is neutralized by ammonia aqueous solution to form alumina slurry. Or, aluminum chloride or aluminum sulfate aqueous solution is mixed with water glass solution to form amorphous silica-alumina slurry.
3) The colloid from (1) mixes with the slurry from (2) for 1-2 hours.
4) The mixture is washed to about pH=9 and free of Cl⁻, and dried in an oven at a temperature in the range from about 373 to about 423K.
5) The mixture from (4) is calcinated or hydrothermally treated.

Then, the hydroprocessing catalyst is prepared either by comulling method, e.g. mixing the hydrogenation metals, the composite, and binder, or by impregnation method, e.g. mixing the composite and binder to form a support followed by impregnated with hydrogenation metals.

The zeolite beta crystallization conditions and gel compositions used in this invention favour the formation of more viable nuclei, and thus far smaller zeolite particles (reaching nano-sized) can be formed from limited “nutrient”. Undesired diffusion limitations are eliminated or decreased during reaction when nano-sized zeolite beta is used in the catalyst. The rapid increased external surface and high fraction of acid sites provide the active sites for the molecules that are too big to enter the pores of zeolites.

Nanocrystal zeolite beta exhibited a higher catalytic activity, lower rate of catalyst deactivation, and higher product quality, compared to conventional type microcrystalline beta material.

Good dispersion of the nano-sized zeolite in the support avoids the aggregation of the zeolite particles, which helps to enhance the stability and activity of the catalyst.

Synthesis of nano-sized zeolite composite makes the nano-sized zeolite separation and washing easier, and increases the yield of the zeolite.

When the present invented catalyst is used to hydroprocess light cycle oil (LCO), compared with conventional commercialized catalyst, the hydrodenitrogenation (HDN), hydrodesulferization (HDS), and hydrodearomatization (HDA) activities increase 1.68 wt %, 3.54 wt %, and 1.6 wt % respectively. The detailed results are listed below in Table 1.

TABLE 1

| Catalyst | Conventional | Present invention |
|---|---|---|
| HDN, % | 94.99 | 97.67 |
| HDS, % | 90.69 | 94.23 |
| HDA, % | 11.80 | 13.40 |

As can be seen from the results and comparison in Table I, the catalyst disclosed herein may be used in any refineries which have hydroprocessing units. The new catalysts can improve the HDS, HDN, and HDA activities, the stabilities of the catalyst. All these performance is urgently needed by refineries in order to produce ultra-clean fuel to meet new regulations.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A hydrotreating catalyst for desulfurization of diesel distillates comprising between about 5 to about 75 wt % nano-sized zeolite beta composite, about 10 to about 30 wt % of a hydrogenation metal/alloy and between about 5 to about 20 wt % binder.

2. The hydrotreating catalyst according to claim 1 wherein said hydrogenation metal/alloy is selected from the group consisting of tungsten nickel (WNi), molybdenum cobalt (MoCo), and molybdenum nickel (MoNi), and any combination thereof.

3. The hydrotreating catalyst according to claim 1 wherein a particle size of said zeolite beta in the catalyst is in a range from about 10 to about 100 nm.

4. The hydrotreating catalyst according to claim 1 wherein the nano-sized zeolite beta in the composite is present in a range from about 1 to about 30 wt %.

5. The hydrotreating catalyst according to claim 4 wherein the nano-sized zeolite beta in the composite is present in a range from about 5 to about 15 wt %.

6. The hydrotreating catalyst according to claim 1 wherein the binder is Al₂O₃.

7. A method of synthesizing a hydrotreating catalyst for desulfurization of diesel distillates, the method comprising the steps of:
a) synthesizing alumina-zeolite or amorphous Si—Al zeolite composite by the steps of:
i) forming colloidal particles of nano-sized zeolite beta synthesized using a TEAOH-SiO₂—Al(0)-H₂O system,
ii) preparing a slurry of alumina-zeolite or amorphous Si—Al zeolite and mixing said slurry with said colloidal particles in step i) to form a mixture,
iii) washing the mixture to a pH of about 9, and drying the washed mixture at a temperature in a range from about 100 to about 140° C. to form a washed and dried mixture;
iv) calcinating or hydrothermally treating the washed and dried mixture to form the prepared composite;
b) preparing the hydrotreating catalyst by mixing the prepared composite with hydrogenation metals and binder, and form extrudates or pellets (support); or mixing the composite and binder to form extrudates or pellets followed by impregnated with hydrogenation metals; and
c) treating the hydrotreating catalyst by drying and calcination.

8. The method according to claim 7 wherein step b) includes comulling the hydrogenation metals, the composite, and binder simultaneously.

9. The method according to claim 7 wherein step b) includes mixing the composite and binder to form a support followed by impregnation by the hydrogenation metals.

10. The method according to claim 8 wherein said step a) i) includes forming colloidal particles of nano-sized zeolite beta synthesized using a TEAOH-SiO₂—Al(0)-H₂O system wherein an oxide precursor gel of the system has a composition given by xTEAOH: ySiO₂: Al₂O₃:zH₂O, where TEAOH is tetraethylammonium hydroxide, and where x ranges from 5 to 50, y from 20 to 500, and z from 100 to 2000;
forming colloidal particles of nano-sized zeolite beta from the precursor gel includes the steps of:
dissolving powdered aluminum metal in a first portion of the TEAOH-containing aqueous solution to form a clear solution, adding this clear solution to the slurry made from fumed silica and a remaining portion of the TEAOH-containing aqueous solution to form an aluminosilicate fluid gel;
stirring the aluminosilicate fluid gel at ambient temperature for a period of time from about 2 to about 6 hours, and then transferring the stirred aluminosilicate fluid gel to an autoclave;
heating the stirred aluminosilicate fluid gel to a temperature in a range from about 350 K to about 550 K for a preselected period of time to crystallize colloidal particles of nano-sized zeolite beta.

11. The method according to claim 10 wherein said stirred aluminosilicate fluid gel is heated to a temperature in a range from about 373 to about 473K.

12. A method for hydrotreating a hydrocarbon containing feed stream of diesel distillates for desulfurization of said diesel distillates comprising the steps of intimately contacting a substantially liquid hydrocarbon containing feed stream, which also contains compounds of sulfur, with a catalyst comprising between about 5 to about 75 wt % nano-sized zeolite beta composite, about 10 to about 30 wt % of a hydrogenation metal/alloy and between about 5 to about 20 wt % binder.

13. The method according to claim 12 wherein said hydrogenation metal/alloy is selected from the group consisting of tungsten nickel (WNi), molybdenum cobalt (MoCo), and molybdenum nickel (MoNi), and any combination thereof.

14. The method according to claim 12 wherein a particle size of said zeolite beta in the catalyst is in a range from about 10 to about 100 nm.

15. The method according to claim 12 wherein the nano-sized zeolite beta in the composite is present in a range from about 1 to about 30 wt %.

16. The method according to claim 15 wherein the nano-sized zeolite beta in the composite is present in a range from about 5 to about 15 wt %.

17. The method according to claim 12 wherein the binder is Al₂O₃.

18. A method for hydrotreating a feed stream of diesel distillates for desulfurization of said diesel distillates comprising the steps of intimately contacting a substantially liquid hydrocarbon containing feed stream, which also contains compounds of sulfur, with a catalyst comprising prepared by a method comprising the steps of:
a) synthesizing alumina-zeolite or amorphous Si—Al zeolite composite by the steps of
i) forming colloidal particles of nano-sized zeolite beta synthesized using a TEAOH-SiO₂—Al(0)-H₂O system,
ii) preparing a slurry of alumina-zeolite or amorphous Si—Al zeolite and mixing said slurry with said colloidal particles in step i) to form a mixture,
iii) washing the mixture to a pH of about 9, and drying the washed mixture at a temperature in a range from about 100 to about 140° C. to form a washed and dried mixture;
iv) calcinating or hydrothermally treating the washed and dried mixture to form the prepared composite;
b) preparing the hydrotreating catalyst by mixing the prepared composite with hydrogenation metals and binder, and form extrudates or pellets (support); or mixing the composite and binder to form extrudates or pellets followed by impregnated with hydrogenation metals and
c) treating the hydrotreating catalyst by drying and calcination.

19. The method according to claim 18 wherein said hydrogenation metal/alloy is selected from the group consisting of tungsten nickel (WNi), molybdenum cobalt (MoCo), and molybdenum nickel (MoNi), and any combination thereof.

20. The method according to claim 18 wherein a particle size of said zeolite beta in the catalyst is in a range from about 10 to about 100 nm.

21. The method according to claim 18 wherein the nano-sized zeolite beta in the composite is present in a range from about 1 to about 30 wt %.

22. The method according to claim 22 wherein the nano-sized zeolite beta in the composite is present in a range from about 5 to about 15 wt %.

23. The method according to claim 18 wherein the binder is Al₂O₃.
